(19) United States
(12) Patent Application Publication
(10) Pub. No.: US 2023/0376839 A1
(43) Pub. Date: Nov. 23, 2023

(54) METHOD FOR PRODUCING DEEP LEARNING SAMPLES IN GEOGRAPHIC INFORMATION EXTRACTION FROM REMOTE SENSING IMAGE

(71) Applicants: Ye Bai, Chengdu (CN); Yuchuan Wang, Chengdu (CN); Jiang Wen, Chengdu (CN)

(72) Inventors: Ye Bai, Chengdu (CN); Yuchuan Wang, Chengdu (CN); Jiang Wen, Chengdu (CN)

(73) Assignee: Sichuan I&P Technology Co., Ltd, Chengdu (CN)

(21) Appl. No.: 17/827,969

(22) Filed: May 30, 2022

(30) Foreign Application Priority Data
May 17, 2022 (CN) 2021112876670

(51) Int. Cl. G06N 20/00

(52) U.S. Cl. CPC G06N 20/00

(57) ABSTRACT

The present invention relates to a method for producing deep learning samples for geographic information extraction from remote sensing images. The samples can be produced by fusing two results from flood fill algorithm in image processing and deep learning model in artificial intelligence. In deep learning reasoning by changing an input image, such as rotation, translation, scaling, color & saturation adjustment and so on, multi-input images can be gotten and the corresponding output results are fused as a result by a rule of “Output by Bitwise Maximum Grayscale”. Finally the fusion result is perfected by man-machine interaction and supplemented to sample set. The method can improve the efficiency of producing deep learning samples, reduce the subjectivity of manual sample production and ensure the sample quality.

### BACKGROUND OF THE INVENTION

The present invention relates to the field of artificial intelligence in geographic information. More particularly, it relates to a method for producing deep learning samples in geographic information extraction from remote sensing image.

Nowadays a large of remote sensing images can be shotted by spaceborne or airborne remote sensors and this technique has been used widely in building or renewing the geographic information system (GIS). The geographic information is one of main and important information in the modern social. The geographic information extraction is valuable in social economics. The traditional technique of extracting geographic information from remote sensing images is that remote sensing images are manually annotated by professional persons. It is extreme low efficient due to taking lots of time and manpower. Modern geographic information system requires higher processing efficiency and better quality.

With development of artificial intelligence (AI), more and more geographic information extraction makes use of the learning machine, especially the deep learning model. This technique can advance the efficiency of producing geographic information data greatly to meet the need of human social activities for geographic information.

However, in the AI processing of remote sensing images, a complete deep learning model needs lots of training samples and extreme low efficiency in producing samples is a main problem in geographic information extraction from remote sensing images by AI. Around the world, lots of professional institutes, enterprises and universities have taken lots of professional persons and time for building the sample sets for geographic information extraction by AI from remote sensing data. So, it is very important to advance the efficiency of producing deep learning samples. It is an efficient solution for this problem by combining deep learning model and image processing for the highly efficient sample production.

### SUMMARY OF THE INVENTION

A technique for producing deep learning samples in extracting geographic information is provided in the present invention. More specifically, the present invention provides a method for producing deep learning samples in extracting geographic information from remote sensing images by combining AI and image processing technique. The purpose of the present invention is to improve the sample producing efficiency and supporting the deep learning model in geographic information.

According to the present invention, a method for producing deep learning samples in extracting geographic information from remote sensing images is provided. The operation steps as following:
1. Selecting an area from a remote sensing image as a processed unit;
2. Producing a binary graph of the object by flood fill algorithm;
3. Producing a binary graph of the object by deep learning model with pre-weight;
4. Fusing the two binary graphs in step 2 and 3, the binary graph of the object is gotten;
5. Completing the binary graph by man-machine interaction and adding the result to the sample set;
6. Training the deep learning model in step 3 using the new sample set and renewing the model weight;
7. Repeating step 1-6 and adding more samples to the sample set.

According to a specific embodiment, there can be many benefits and/or advantages. The present invention produces the deep learning sample set to extract the geographic information from remote sensing images. In the present invention the area processed by flood fill algorithm and deep learning model is selected as a unit by determining the seed point of the object. The efficiency and quality of producing sample will be advanced by fusing the two results from flood fill algorithm and deep learning model respectively. At the same time, the adaption and accuracy of the deep learning model is better by renewing the weight of the model. Generally, the sample set can be produced quickly and accurately by the present invention.

### BRIEF DESCRIPTION OF THE DRAWINGS

FIG. 1 illustrates a flow chart of the method for producing deep learning samples in geographic information extraction from remote sensing image according to an embodiment of the present invention;

FIG. 2 is an example of selecting the seed point on the object according to the request, in FIG. 2 (a) the suggestion area is showed by the arrow and in FIG. 2 (b) the non-suggestion areas are showed by the flechas;

FIG. 3 is an example of flood fill algorithm. FIG. 3 (a) is the original image of a unit and the point with coordinates is the seed selected, FIG. 3 (b) is the extract result, FIG. 3 (c) is the extract results with seed near the noise, FIG. 3 (d) is the extract result after filtering;

FIG. 4 is the deep learning reasoning result. FIG. 4 (a) is an original image, FIG. 4 (b) is the reasoning result of FIG. 4 (a), FIG. 4 (c) is the image changed by translation and zoon of FIG. 4 (a), FIG. 4 (d) is the reasoning result of FIG. 4 (c). FIG. 4 (e) is another original image, FIG. 4 (f) is the reasoning result of FIG. 4 (e), FIG. 4 (g) is the image changed in saturation and colour of FIG. 4 (e), FIG. 4 (h) is the reasoning result of FIG. 4 (g);

FIG. 5 is the fusion result by deep learning model and flood fill algorithm, FIG. 5 (a) is an original image, FIG. 5 (b) is the extraction result p1 by flood fill algorithm, FIG. 5 (c) is the reasoning result p2 by deep learning model, FIG. 5 (d) is the binary graph p3 from FIG. 5 (c) according to the rule of “Output by Bitwise Maximum Grayscale”, FIG. 5 (e) is the fusion result p4 of p1 and p3;

FIG. 6 illustrates the contrast among the training samples by man-machine interaction, FIG. 5 (a) is the binary graph p4, FIG. 5 (b) is the result from p4 by open-close processing, FIG. 5 (c) is the result marking the redundant by open-close processing, FIG. 5 (d) is the result by man-machine interaction.

### DETAILED DESCRIPTION OF SPECIFIC EMBODIMENTS

In the following, a specific embodiment of the present invention will be described in detail with reference to the accompanying drawings such that those skilled in the art can better understand the invention. In the embodiment it is noted that well-known functions and configurations are not described in detailed to avoid obscuring the present invention.

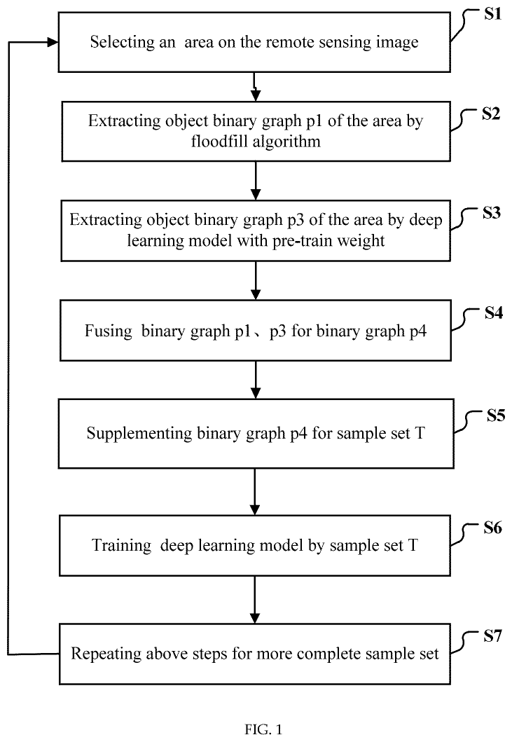

According to the present invention, a method of deep learning sample production in the geographic information extraction from remote sensing images is provided. As showed in FIG. 1 a flow chart of the method according to an embodiment of the present invention comprises the steps of:

S1. Selecting an area from the remote sensing image as a unit.

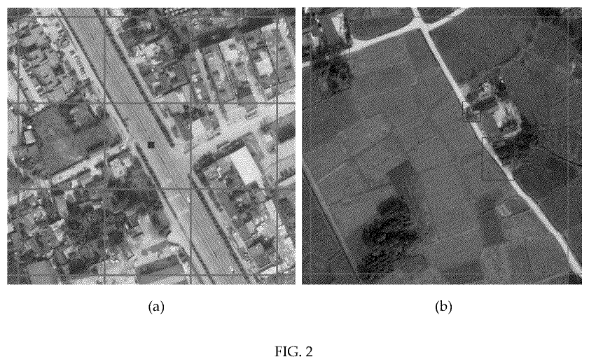

As an example, the original image to be processed is a high resolution optical remote sensing image which we show an example in FIG. 2. A pixel on the object (the object is the road in the embodiment) is selected as a seed point from the remote sensing image. In FIG. 2 (a) the requirement for selecting seed point is that the seed point must be on the object and the position of the seed point should make the unit including more object pixels. The seed point cannot be on the object shielded and closing to noise image showed in In FIG. 2 (b). Then an image centered on the seed point with N×M pixels is selected as a processed unit.

Normally N,M=L×2ⁿ, L, n is integer. N≠M or N=M is allowed. In the embodiment N=3×2ⁿ, M=2×2ⁿ, n=128.

In the invention, the different shape of the selected units is allowed and the units can have overlap. The selected units should be signed to avoid double selection.

S2. The extracting binary graph p1 by flood fill algorithm.

The binary graph p1 of the unit with the seed point selected by S1 can be gotten by flood fill algorithm. The flood fill algorithm is according to the color of the seed point. If there is noise on the unit the extraction result is empty and makes the object discontinuity. By mean filtering and image sharpening the result discontinuity can be improved and the result quality will be advanced.

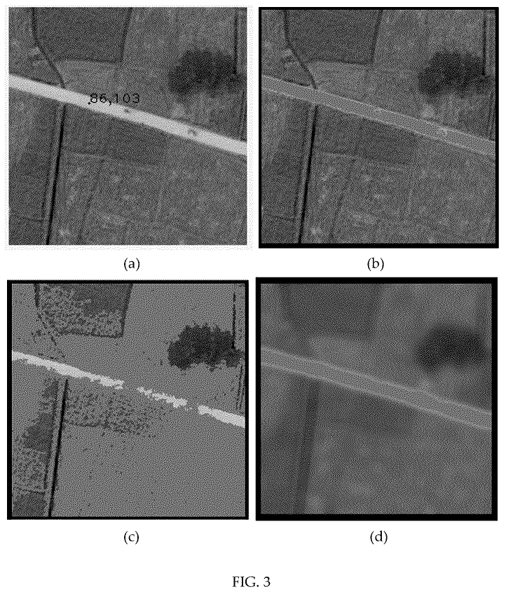

In the embodiment FIG. 3 (a) is the original image of a unit and the black point with coordinate is the seed point selected, FIG. 3 (b) is the extraction result of flood fill algorithm using a normal seed, FIG. 3 (c) is that using a seed point near noise and FIG. 3 (d) is the result of the flood fill algorithm after filtering the original image. FIG. 3 shows that the extraction result after filtering the original image is better.

S3. The extracting binary graph p3 by deep learning model with pre-training weight.

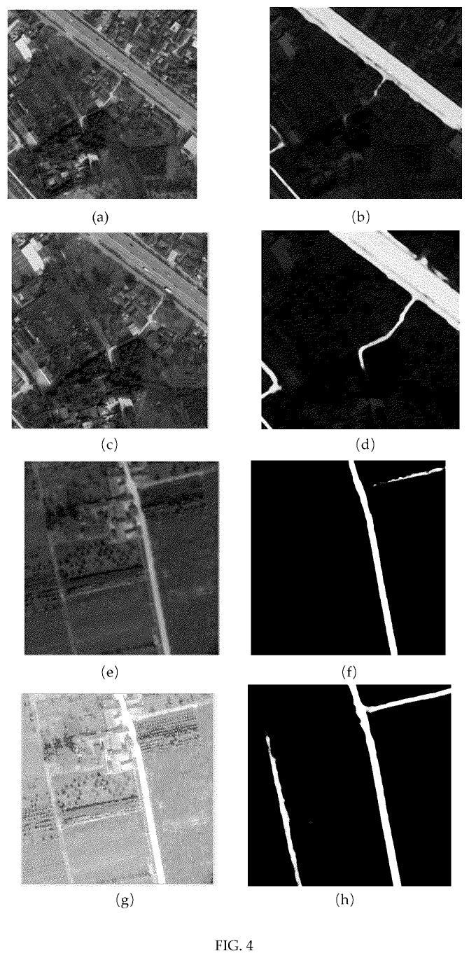

First several images are gotten by changing a unit by different ways. In the embodiment the changing ways are rotation, translation, scaling, color and saturation adjustment. By the changing more training samples are gotten and the sample set is enriched, the reasoning results will be better. It is showed in FIG. 4 (a), (c), (e), (g).

Second the reasoning results are gotten by inputting these changed units into deep learning model. The outputs of the deep learning model are grayscale graphs and the pixel grayscale means the probability that the pixel belongs to the object area. FIG. 4 (b), (d), (f), (h) are the reasoning results by deep learning model corresponding to FIG. 4 (a), (c), (e), (g). Comparing FIGS. 4 (b) and (d), the geographic information in FIG. 4 (d) by translate & scale is more than that in FIG. 4 (b). Comparing FIGS. 4 (h) and (f), the geographic information in FIG. 4 (h) by HSV (Hue, Saturation and Value) parameter adjustment is more. Generally, the model has different performance for input images changed by different way.

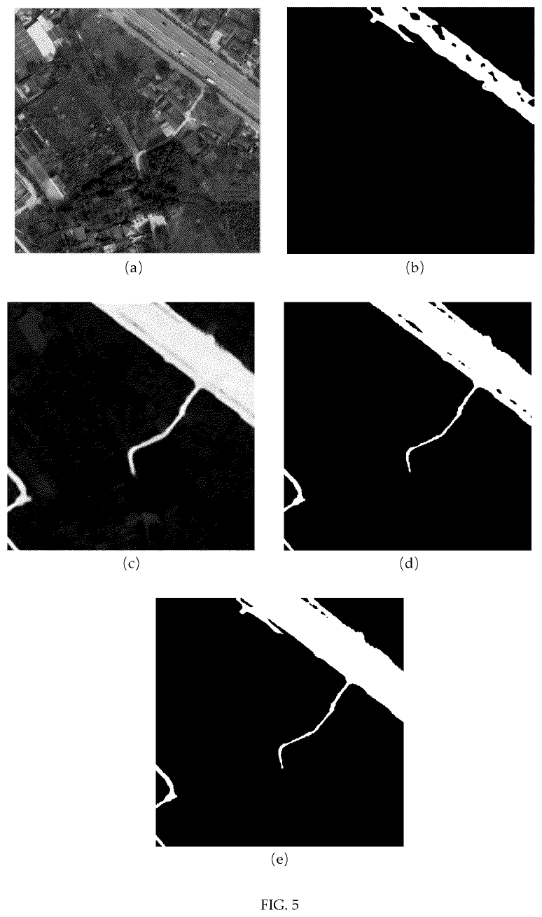

Finally, by inverse rotation, translation, scale, color and saturation adjustment, the several graphs with the pixels corresponding to those in the unit selected in S1 are gotten. These graphs are fused to one graph p2 according to the rule “Output by Bitwise Maximum Grayscale”. FIG. 5 (c) is the result from FIG. 5 (a) by fusing several graphs.

The rule “Output by Bitwise Maximum Grayscale” is comparing the grayscale of the pixels at same position of several graphs, the maximum grayscale is output, as following:

$$\begin{matrix}\begin{matrix}{O}_{y} = \{ {a}_{i\_j \_y} \} = [ \begin{matrix}{a}_{1 \_ 1 \_ y} & … & {a}_{1 \_ 512 \_ y} \\ ⋮ & ⋱ & ⋮ \\ {a}_{512 \_ 1 \_ y} & … & {a}_{512 \_ 512 \_ y}\end{matrix} ] & ( i = 1 , … M , j = 1 , … N , y = 1 , … K )\end{matrix} \\ \begin{matrix}O = {max}_{y} {\{ {a}_{i\_j \_y} \}}_{i\_j} = [ \begin{matrix}{max}_{y} ( {a}_{1 \_ 1 \_ y} ) & … & {max}_{y} ( {a}_{1 \_ 512 \_ y} ) \\ ⋮ & ⋱ & ⋮ \\ {max}_{y} ( {a}_{512 \_ 1 \_ y} ) & … & {max}_{y} ( {a}_{512 \_ 512 \_ y} )\end{matrix} ] & ( y = 1 , … K )\end{matrix}\end{matrix}$$

Here, O_{y} is the y-th reasoning result, y in range of 1-K, K is number of reasoning results for an unit, i, j is the length and width of the unit.

By the threshold value, the graph p2 is transferred to a binary graph p3. The grayscale of the object pixels is 1, other is 0. FIG. 5 (d) is the binarization result.

In the embodiment the integrity of the object advances greatly by the image changing and the rule “Output by Bitwise Maximum Grayscale”.

S4. The binary graph p1 and p3 fusion to the object binary graph p4.

p1 is the result by flood fill algorithm and p3 is the result by deep learning model. The object binary graph p4 is gotten by the logic OR fusion of p1 and p3. FIG. 5 (e) is fusion result of FIG. 5 (b) and FIG. 5 (d), the extraction result quality advances greatly.

S5. The object binary graph p4 supplement to the sample set after morphologic operating.

First, the morphological open and close operation are performed on the binary graph p4 for optimizing the results. Open operation is removing smaller bright details. Close operation is filling the small holes on the object area.

Morphological operation is trimming edge, removing noise points and filling holes, including eroding and dilating, as following:

f∘b=(f⊙b)⊕b f·b=(f⊕b)⊙b

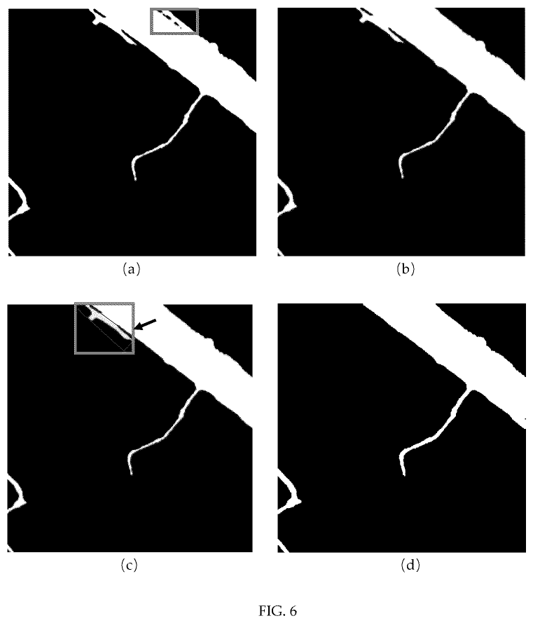

Here operator”∘“is open operation and “⋅” close operation. f is binary graph and b is structure element. ⊙ and ⊕ are eroding and dilating operator respectively. FIG. 6(b) is the morphological operation result of FIG. 6 (a), box shows the filled hole.

After morphological operation the binary graph is improved in way of man-machine interaction as p5. The objects that are missed and over-extracted should be completed manually as in FIG. 6(c) marked by polygon.

The final result is showed in FIG. 6(d).

The binary graph p5 and the unit selected in S1 constructs a pair of training sample for deep learning model, by adding it into the sample set a renewal set T is gotten.

S6. Renewing weight parameters of the model by Training the deep learning model using sample set T.

Using the sample set T the deep learning model in S3 is trained and a new set of model parameters is gotten. The new deep learning model with better generalization can be gotten with producing sample set.

S7. Repeating the above steps for more samples by selecting new seed points.

In the invention new seed points are selected from the unmarked area, but no exactly limit location. The areas of seed points can be overlap.

### General

Unless specifically stated, otherwise as apparent from the following discussions, it is appreciated that throughout the specification discussions utilizing terms such as “processing,” “computing,” “producing,” “determining,” “extracting,” “fusing” or the like, refer to the action and/or processes of a host device or computing system, or similar electronic computing device, that manipulate and/or transform data represented as physical, such as electronic, quantities into other data similarly represented as physical quantities.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a host device system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

All publications, patents, and patent applications cited herein are hereby incorporated by reference, except in those jurisdictions where incorporation by reference is not permitted. In such jurisdictions, the Applicant reserves the right to insert portions of any such cited publications, patents, or patent applications if Applicant considers this advantageous in explaining and/or understanding the disclosure, without such insertion considered new matter.

Any discussion of prior art in this specification should in no way be considered an admission that such prior art is widely known, is publicly known, or forms part of the general knowledge in the field.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression an image comprising A and B should not be limited to images consisting only of A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms extracting and “producing,” along with their derivatives, may be used. It should be understood that these terms are not intended as synonyms for each other. Thus, the scope of the expression an image A extracted from an image B should not be limited to images wherein an image A is directly extracted from an image B. It means that there exists a path between an image A and an image B which may be a path including other means. “fused” may mean that two or more images are either in direct procession, or that two or more images are not in direct procession still interact with each other.

The term “image” typically represents a digital representation of an image. It may represent a digital grey scale or colour image with multiple channels, including meta channels such as depth and transparency.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Note that the claims attached to this description form part of the description, so are incorporated by reference into the description, each claim forming a different set of one or more embodiments.

What is claimed is:

1. A method for producing deep learning samples of geographic information extraction from remote sensing images, the method comprising:
1) Selecting an area from a remote sensing image as the processed unit;
2) Extracting the binary graph of the unit by flood fill algorithm;
3) Extracting the binary graph of the unit by deep learning model with pre-train weight;
4) Producing the object binary graph by fusing the above two binary graphs;
5) Completing the object binary graph by man-machine interaction and adding the sample to the sample set;
6) Training the deep learning model using in the new sample set and renewing the weight parameters of the deep learning model;
7) Repeating S1-6 and adding more samples to the sample set.

2. The method of claim 1 wherein a method of producing deep learning samples of geographic information extraction from remote sensing images comprising:
1) Selecting a seed point on the object from a remote sensing image by man-machine interaction;
2) Cuting out N×M pixels and centering on the seed point as a processed unit from an image.

3. The method of claim 1 wherein the object binary graph extraction by flood fill algorithm comprising:
1) Mean filtering and sharping the unit;
2) Using the seed point in above step for floodfill algorithm in extracting the object binary graph.

4. The method of claim 1 wherein extracting object binary graph by deep learning model with pre-train weight comprising:
1) Changing the image of the unit by several ways for producing several images;
2) Inputing these images into deep learning model with pre-train weight and outputing several graphs;
3) Inverse changing these graphs and producing the graphs with pixels corresponding that in original images;
4) Fusing these graphs to a graph by the rule “Output by Bitwise Maximum Grayscale”;
5) Producing the object binary graph by setting the threshold value.

5. The method of claim 1 wherein the two binary graphs by flood fill algorithm and deep learning model are fused to an object binary graph using logic OR algorithm.

6. The method of claim 1 wherein completing the object binary graph by man-machine interaction and adding it to sample set comprising:
1) Morphological open and close operation to the object binary graph;
2) Completing the object binary graph by man-machine interaction;
3) Adding the object binary graph to the sample set for renewing sample set.
